(19) United States
(12) Patent Application Publication
(10) Pub. No.: US 2017/0300225 A1
(43) Pub. Date: Oct. 19, 2017

(54) DISPLAYING APPLICATION PAGE OF MOBILE TERMINAL

(71) Applicant: Alibaba Group Holding Limited, Grand Cayman (KY)

(72) Inventor: Leo Cheung, Zhejiang (CN)

(21) Appl. No.: 15/642,123

(22) Filed: Jul. 5, 2017

Related U.S. Application Data
(63) Continuation of application No. PCT/CN2016/070129, filed on Jan. 5, 2016.

(30) Foreign Application Priority Data
Jan. 13, 2015 (CN) 201510017262.3

(51) Int. Cl. G06F 3/0488

(52) U.S. Cl. CPC G06F 3/04883; G06F 2203/04803

(57) ABSTRACT

A method for displaying an application page of a mobile terminal includes: determining an application currently displayed by the mobile terminal; monitoring a screen of the mobile terminal, if a user is monitored to perform a first gesture on the screen of the mobile terminal, determining a triggered control according to a currently displayed page of the application and a pre-stored corresponding relationship between the first gesture and a response sequence between different levels of pages of the application and at least one control on a same level of page; and displaying a page corresponding to the triggered control. The techniques of the present disclosure simplify operation steps, reduce the number of confirmations, and make operations more convenient.

### CROSS REFERENCE TO RELATED PATENT APPLICATIONS

This application claims priority to and is a continuation of PCT Patent Application No. PCT/CN2016/070129, filed on 5 Jan. 2016, which claims priority to Chinese Patent Application No. 201510017262.3, filed on 13 Jan. 2015, entitled “METHOD AND APPARATUS FOR DISPLAYING APPLICATION PAGE OF MOBILE TERMINAL,” which are hereby incorporated by reference in their entirety.

### TECHNICAL FIELD

The present disclosure relates to the technical field of mobile terminal technologies, and in particular, to a method and an apparatus for displaying an application page of a mobile terminal.

### BACKGROUND

With the rapid development of the mobile Internet technology, mobile terminals (e.g., mobile phones, tablet computers, and the like) have become increasingly popular, and there are more and more functions provided by the mobile terminals. Under normal circumstances, users can install various Applications (Apps) on mobile terminals. For example, a user can install Taobao™ App on a mobile phone, and then conduct online shopping.

At present, when a multi-level page is displayed by using a mobile terminal, a user needs to constantly press a confirmation button, and the mobile terminal progressively displays more details layer by layer. For example, after entering the homepage of Taobao™, the user inputs a keyword and conducts a search and, after a search result is obtained from the mobile terminal, the search result is displayed on a search result page. The user clicks a product of interest, and enters a main page corresponding to the product to view related data. If more data is needed, the user needs to click a button to request details once again to enter a product detail page for viewing.

If the above viewing manners are adopted, not only are the steps complicated, but also the operation path is long, which requires multiple clicks for confirmation thereby causing a lot of inconveniences to users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure is intended to at least solve one of the technical problems in the related art to some extent. To this end, an objective of the present disclosure is to provide a method for displaying an application page of a mobile terminal. The method may simplify operation steps, reduce the number of confirmations, and make operations more convenient.

Another objective of the present disclosure is to provide an apparatus for displaying an application page of a mobile terminal.

In order to achieve the above objective, according to an aspect of the present disclosure, an example embodiment provides a method for displaying an application page of a mobile terminal, including: determining an application currently displayed by the mobile terminal; and monitoring a screen of the mobile terminal, if a user is monitored to perform a first gesture on the screen of the mobile terminal, determining a triggered control according to a currently displayed page of the application and a pre-stored corresponding relationship between the first gesture and a response sequence between different levels of pages of the application and at least one control on a same level of page, and displaying a page corresponding to the triggered control.

In the method for displaying an application page of a mobile terminal according to the example embodiment of the present disclosure, an application currently displayed by the mobile terminal is determined, a screen of the mobile terminal is monitored. If a user is monitored to perform a first gesture on the screen of the mobile terminal, a triggered control is determined according to a currently displayed page of the application and a pre-stored corresponding relationship between the first gesture and a response sequence between different levels of pages of the application and at least one control on a same level of page, and a page corresponding to the triggered control is displayed, thus simplifying operation steps, reducing the number of confirmations, and making operations more convenient.

For example, the method may further comprise establishing and storing the corresponding relationship between the first gesture and the response sequence between different levels of pages of the application and at least one control on the same level of page.

For example, the method may further comprise in response to determining that the user is monitored to perform a second gesture on the screen of the mobile terminal, determining an another triggered control according to the currently displayed page of the application and a pre-stored another corresponding relationship between the second gesture and a response sequence between different levels of pages of the application and at least one control on a same level of page.

For example, the method may further comprise displaying another page corresponding to the another triggered control.

For example, the method may further comprise establishing and storing the another corresponding relationship between the second gesture and the response sequence between different levels of pages of the application and at least one control on the same level of page.

For example, the first gesture is one of a pinch gesture and an open gesture; and the second gesture is the other one of the pinch gesture and the open gesture.

For example, the displaying the page corresponding to the triggered control includes:

determining, according to the first gesture, a distance between corresponding fingers;

determining that the distance is less than or equal to a predetermined threshold; and

displaying the page corresponding to the triggered control.

For example, the method may further comprise:

determining, according to the first gesture, a distance between corresponding fingers;

determining that the distance is greater than the predetermined threshold; and

displaying, according to the response sequence, a thumbnail of a page corresponding to the triggered control.

For example, the method may further comprise:

monitoring an operation of the user; and

in response to determining that the user is monitored to perform a first operation, displaying the page corresponding to the triggered control.

For example, the method may further comprise:

monitoring an operation of the user; and

in response to determining that the user is monitored to perform a second operation, displaying a page corresponding to a next control according to the response sequence.

In order to achieve the above objective, according to an aspect of the present disclosure, an example embodiment provides an apparatus for displaying an application page of a mobile terminal, including: a determination module configured to determine an application currently displayed by the mobile terminal; and a processing module configured to monitor a screen of the mobile terminal, and, if a user is monitored to perform a first gesture on the screen of the mobile terminal, to determine a triggered control according to a currently displayed page of the application and a pre-stored corresponding relationship between the first gesture and a response sequence between different levels of pages of the application and at least one control on a same level of page, and display a page corresponding to the triggered control.

In the apparatus for displaying an application page of a mobile terminal according to the example embodiment of the present disclosure, an application currently displayed by the mobile terminal is determined, a screen of the mobile terminal is monitored. If a user is monitored to perform a first gesture on the screen of the mobile terminal, a triggered control is determined according to a currently displayed page of the application and a pre-stored corresponding relationship between the first gesture and a response sequence between different levels of pages of the application and at least one control on a same level of page. A page corresponding to the triggered control is displayed, thus simplifying operation steps, reducing the number of confirmations, and making operations more convenient.

Another aspect of the present disclosure provides an apparatus for displaying an application page of a mobile terminal, the apparatus comprising:

one or more processors; and

one or more memories stored thereon computer readable instructions that, when executed by the one or more processors, cause the one or more processors to perform acts comprising:
determining an application currently displayed by a mobile terminal;
monitoring a screen of the mobile terminal;
in response to determining that a user is monitored to perform a first gesture on the screen of the mobile terminal, determining a triggered control according to a currently displayed page of the application and a pre-stored corresponding relationship between the first gesture and a response sequence between different levels of pages of the application and at least one control on a same level of page; and
display a page corresponding to the triggered control.

For example, the acts further comprise:

in response to determining that the user is monitored to perform a second gesture on the screen of the mobile terminal, determine an another triggered control according to the currently displayed page of the application and a pre-stored another corresponding relationship between the second gesture and a response sequence between different levels of pages of the application and at least one control on the same level of page; and

display another page corresponding to the another triggered control.

For example, the acts further comprise:

establishing and storing the another corresponding relationship between the second gesture and the response sequence between different levels of pages of the application and at least one control on the same level of page.

For example, the first gesture is one of a pinch gesture and an open gesture; and

the second gesture is the other one of the pinch gesture and the open gesture.

For example, the acts further comprise:

establishing and storing the another corresponding relationship between the second gesture and the response sequence between different levels of pages of the application and at least one control on the same level of page.

For example, the displaying the page corresponding to the triggered control includes:

determining, according to the first gesture, a distance between corresponding fingers;

determining that the distance is less than or equal to a predetermined threshold; and

displaying the page corresponding to the triggered control.

For example, the acts further comprise:

determining, according to the first gesture, a distance between corresponding fingers;

determining that the distance is greater than the predetermined threshold; and

displaying, according to the response sequence, a thumbnail of a page corresponding to the triggered control.

For example, the acts further comprise:

monitoring an operation of the user; and

in response to determining that the user is monitored to perform a first operation, displaying the page corresponding to the triggered control.

Another aspect of the present disclosure provides one or more memories stored thereon computer readable instructions that, when executed by one or more processors, cause the one or more processors to perform acts comprising:

determining an application currently displayed by a mobile terminal;

monitoring a screen of the mobile terminal;

in response to determining that a user is monitored to perform a first gesture on the screen of the mobile terminal, determining a triggered control according to a currently displayed page of the application and a pre-stored corresponding relationship between the first gesture and a response sequence between different levels of pages of the application and at least one control on a same level of page; and

display a page corresponding to the triggered control.

For example, the first gesture includes a pinch gesture or an open gesture

Additionally, some aspects and advantages of the present disclosure will be provided in the following description, and some will become evident in the following description or will be understood through the practice of the present disclosure.

### BRIEF DESCRIPTION OF THE DRAWINGS

The aspects and advantages of the present disclosure will be easily understand from the following description of the example embodiments with reference to the accompanying drawings.

FIG. 1 is a flowchart of a method for displaying an application page of a mobile terminal according to an example embodiment of the present disclosure;

FIG. 2 is a schematic diagram of an effect of displaying a search result page according to an example embodiment of the present disclosure;

FIG. 3 is a schematic diagram of an effect of displaying an article homepage according to an example embodiment of the present disclosure;

FIG. 4 is a schematic diagram of an effect of displaying a detail page corresponding to an article according to an example embodiment of the present disclosure;

FIG. 5 is a first schematic diagram of an effect of displaying a level guide prompt according to an example embodiment of the present disclosure;

FIG. 6 is a second schematic diagram of an effect of displaying a level guide prompt according to an example embodiment of the present disclosure;

FIG. 7 is a third schematic diagram of an effect of displaying a level guide prompt according to an example embodiment of the present disclosure;

FIG. 8 is a fourth schematic diagram of an effect of displaying a level guide prompt according to an example embodiment of the present disclosure;

FIG. 9 is a flowchart of a method for displaying an application page of a mobile terminal according to a specific example embodiment of the present disclosure; and

FIG. 10 is a schematic structural diagram of an apparatus for displaying an application page of a mobile terminal according to an example embodiment of the present disclosure.

### DETAILED DESCRIPTION

Example embodiments of the present disclosure are described in detail in the following, and examples of the example embodiments are illustrated in the accompanying drawings. Identical or similar reference signs, from beginning to end, indicate identical or similar elements or elements having identical or similar functions. The example embodiments described in the following with reference to the accompanying drawings are exemplary, and intended to explain the present disclosure instead of being understood as limitations to the present disclosure.

A method and an apparatus for displaying an application page of a mobile terminal according to the example embodiments of the present disclosure are described in the following with reference to the accompanying drawings.

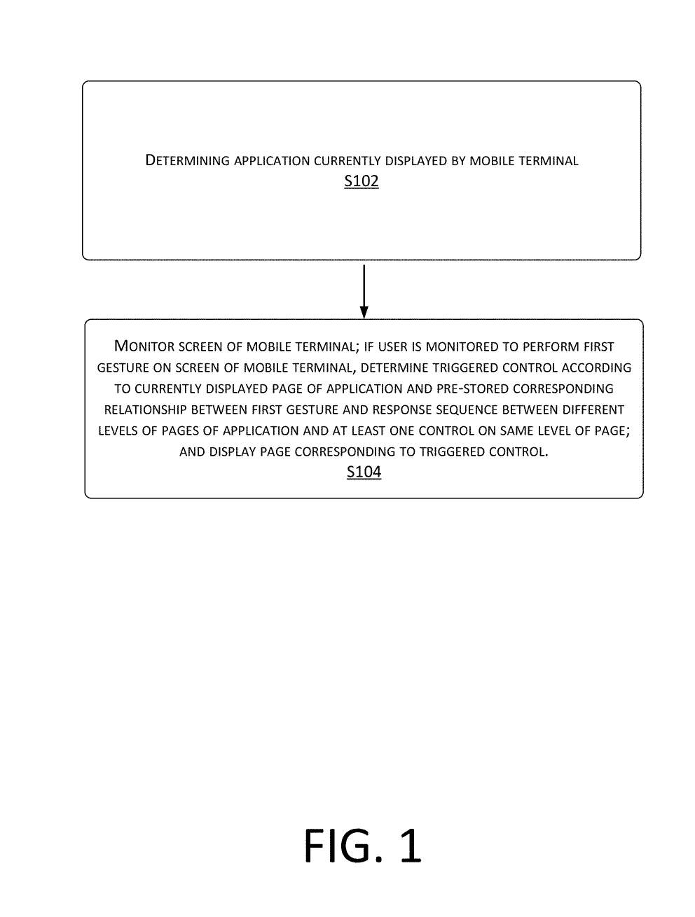

FIG. 1 is a flowchart of a method for displaying an application page of a mobile terminal according to an example embodiment of the present disclosure.

As shown in FIG. 1, the method for displaying an application page of a mobile terminal includes:

S102. Determining an application currently displayed by the mobile terminal.

In the example embodiment of the present disclosure, an application currently displayed by the mobile terminal may be determined. Wherein the application currently displayed may be a communication and social application such as Weibo and WeChat, may also be an audio and video application such as a music player and a video player, and certainly, may also be a shopping application such as a group-buying application and an e-shop application. The mobile terminal may include a mobile phone, a tablet computer, a notebook computer, and the like. For example, the application currently displayed by a mobile phone is Taobao™ mobile.

S104. Monitoring a screen of the mobile terminal; if a user is monitored to perform a first gesture on the screen of the mobile terminal, determining a triggered control according to a currently displayed page of the application and a pre-stored corresponding relationship between the first gesture and a response sequence between different levels of pages of the application and at least one control on a same level of page; and displaying a page corresponding to the triggered control.

In the example embodiment of the present disclosure, after the application currently displayed by the mobile terminal is determined, a screen of the mobile terminal may be monitored. If a user is monitored to perform a first gesture on the screen of the mobile terminal, a triggered control may be determined according to a currently displayed page of the application and a pre-stored corresponding relationship between the first gesture and a response sequence between different levels of pages of the application and at least one control on a same level of page, and a page corresponding to the triggered control is displayed. The first gesture may include, but is not limited to, an open gesture.

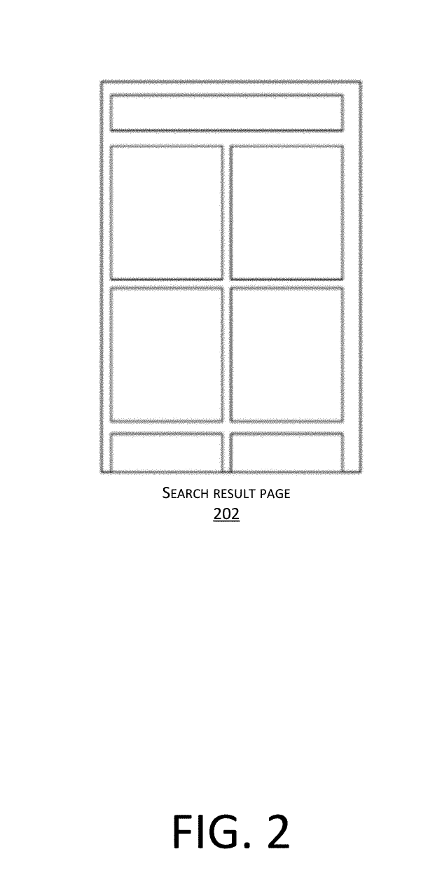

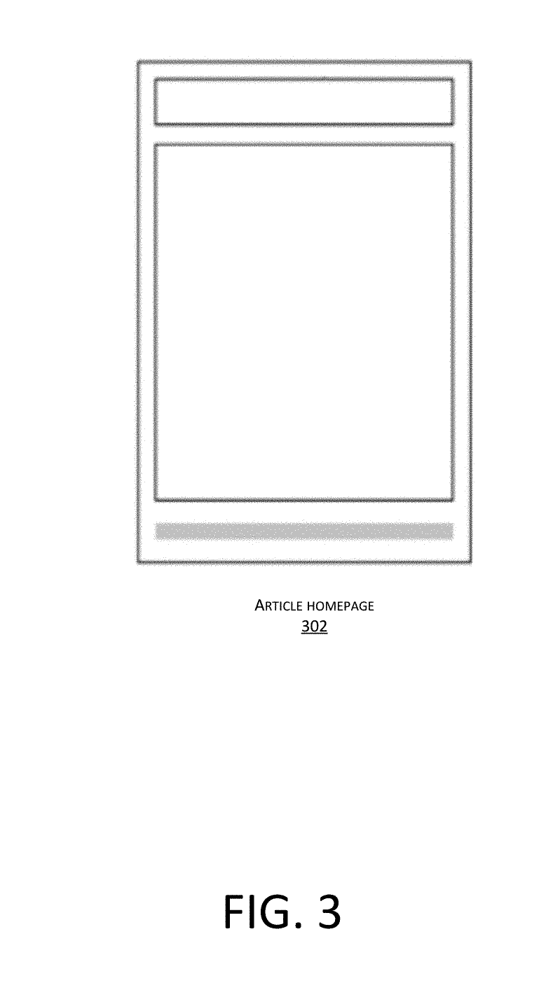

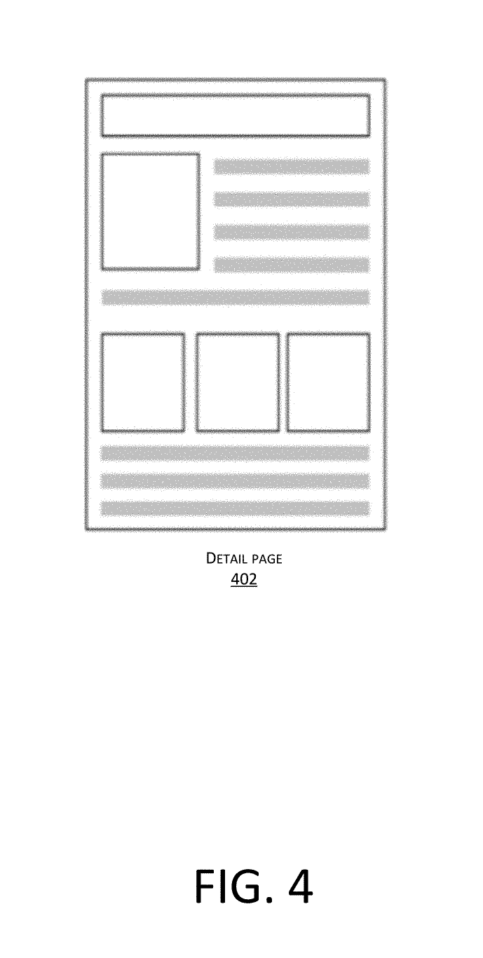

For example, the application currently displayed by the mobile phone is Taobao′ mobile. As shown in FIG. 2, the currently displayed page is a search result page 202, each article corresponds to one control, and an article homepage corresponding to the article may be displayed if the corresponding control is triggered. When a user is monitored to perform an open gesture for an article on the search result page 202, an article homepage 302, as shown in FIG. 3, corresponding to the article may be displayed by triggering the control, i.e., the display page is jumped from FIG. 2 to FIG. 3. If the user wants to further view detailed information of the article, the user may perform the open gesture again, and after the operation is monitored, a detail page 402, as shown in FIG. 4, corresponding to the article may be displayed by triggering a corresponding control, i.e., the display page is jumped from FIG. 3 to FIG. 4.

Further, when the page corresponding to the triggered control is displayed, a distance between corresponding fingers may be determined according to the first gesture, and it is judged whether the distance is greater than a predetermined threshold. If the distance is less than or equal to the predetermined threshold, the page corresponding to the triggered control is displayed. For example, when the user is monitored to perform an open gesture for an article on the search result page 202, if a distance between two fingers of the user is less than or equal to a predetermined threshold, an article homepage 302 corresponding to the article may be displayed, that is, the display page is jumped from FIG. 2 to FIG. 3.

If the distance is greater than the predetermined threshold, a thumbnail of the page corresponding to the triggered control is displayed according to the response sequence, and an operation of the user is monitored. If the user is monitored to perform a first operation, the page corresponding to the triggered control is displayed, and if the user is monitored to perform a second operation, a page corresponding to a next control is displayed according to the response sequence. The first operation may include an operation of loosening the fingers, and the second operation may include an operation of continuously performing the open gesture.

For example, if a distance between two fingers of the user is greater than the predetermined threshold, a thumbnail of the article homepage 302 corresponding to the article may be displayed. If the user wants to enter the article homepage 302 corresponding to the article, the operation of loosening the fingers may be performed, and when the mobile phone monitors the operation, the displayed page is jumped from the search result page 202 to the article homepage 302 corresponding to the article, that is, from the thumbnail of the article homepage 302 to FIG. 3. If the user wants to enter a detail page 402 corresponding to the article, the open gesture may be continuously performed, and when the mobile phone monitors the operation, the displayed page is jumped from the search result page 202, through the thumbnail of the article homepage 302 corresponding to the article, to the detail page 402 corresponding to the article, that is, from FIG. 2, through a thumbnail preview of FIG. 3, to FIG. 4.

If a user is monitored to perform a second gesture on the screen of the mobile terminal, a triggered control is determined according to a currently displayed page of the application and a pre-stored corresponding relationship between the second gesture and a response sequence between different levels of pages of the application and at least one control on a same level of page, and a page corresponding to the triggered control is displayed. W The second gesture may include, but is not limited to, a pinch gesture.

For example, an application currently displayed by a mobile phone is Taobao′ mobile. As shown in FIG. 4, the currently displayed page is a detail page 402 of an article, the detail page 402 corresponds to a control, and an article homepage 302 corresponding to the article may be displayed if a corresponding control is triggered. When a user is monitored to perform a pinch gesture on a detail page 402 of an article, an article homepage 302 corresponding to the article may be displayed by triggering the control, that is, the displayed page is jumped from FIG. 4 to FIG. 3. If the user wants to go back to the search result page 202, the pinch gesture may be performed again, and after the operation is monitored, the search result page 202 may be displayed by triggering the corresponding control, that is, the displayed page is jumped from FIG. 3 to FIG. 2.

It should be understood that the first gesture and the second gesture may also be other gestures, for example, a slide gesture and so on. If the mobile terminal does not have a touch screen, the detail page 402 may also be entered through another operation such as shake.

Certainly, after the user is monitored to perform an open or pinch gesture, a level guide prompt effect may also be displayed.

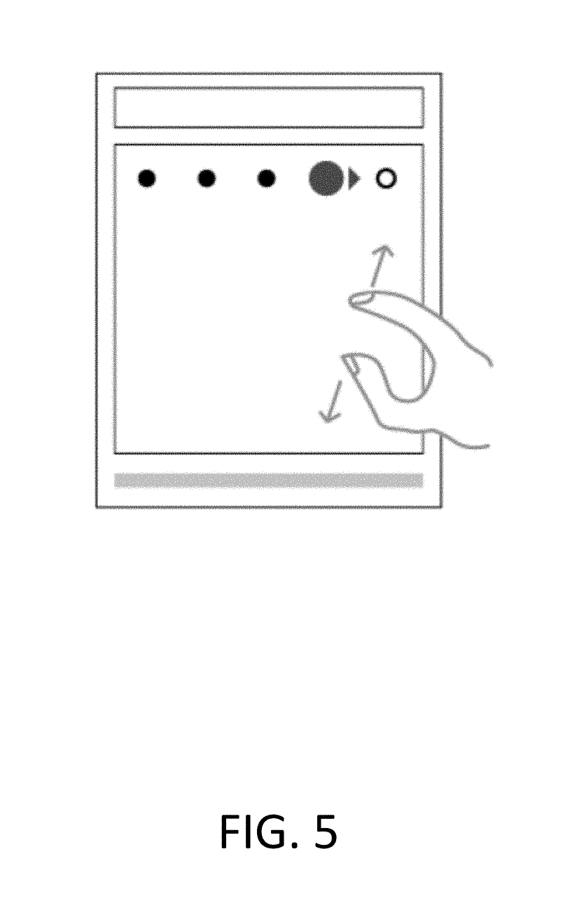

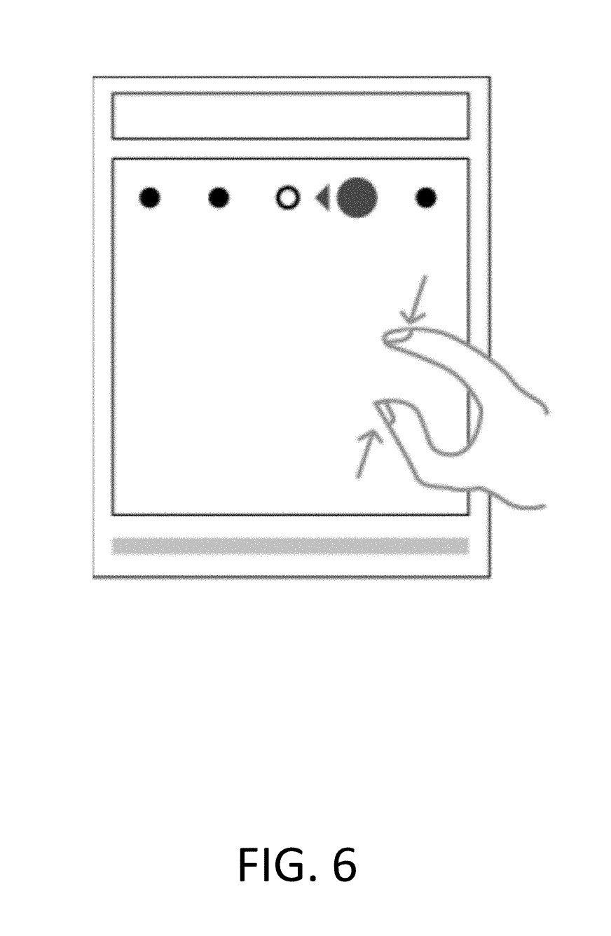

For example, as shown in FIG. 5, the number of levels is indicated with black points above the application page, and a slightly larger point indicates a level corresponding to the currently displayed page. When the user is monitored to perform an open gesture, arrows are used to indicate a jump from a current level to a next level, and the black point corresponding to the next level may become a white point, thus prompting the user. Certainly, the effect is not limited to that the black point becomes a white point, and another prompt effect may also be adopted. Likewise, when the user is monitored to perform a pinch gesture, as shown in FIG. 6, arrows are used to indicate a jump from a current level to a previous level, and the black point corresponding to the previous level may become a white point, thus prompting the user.

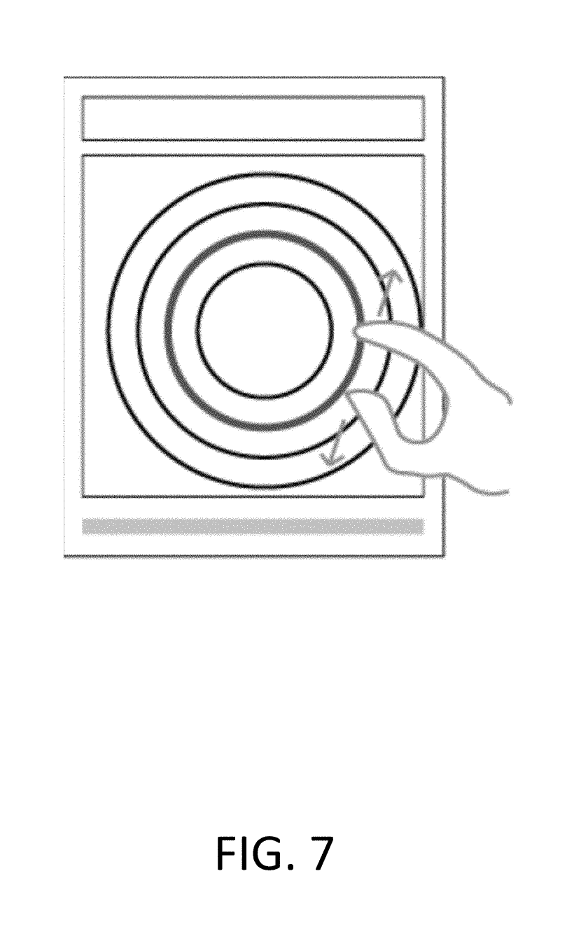

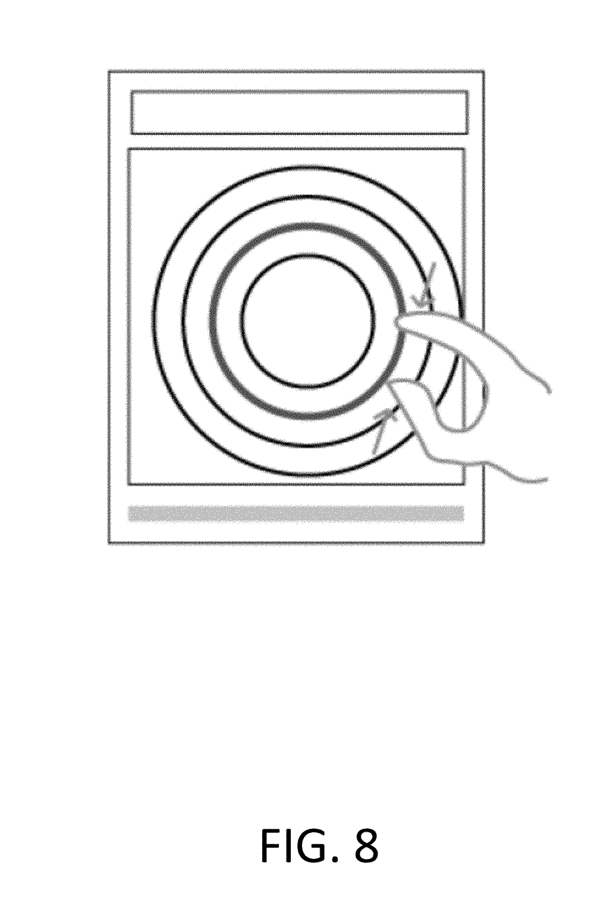

For another example, as shown in FIG. 7, the number of levels is indicated with circles, and a slightly thicker circle indicates a level corresponding to the currently displayed page. When the user is monitored to perform an open gesture, the circle becomes larger along with the gesture, and a paste effect is produced when the circle is about to reach a next level, thus prompting the user. Likewise, when the user is monitored to perform a pinch gesture, as shown in FIG. 8, the circle becomes smaller along with the gesture, and a paste effect is produced when the circle is about to reach a previous level, thus prompting the user.

In addition, before a triggered control is determined according to a currently displayed page of the application and a pre-stored corresponding relationship between the first gesture and a response sequence between different levels of pages of the application and at least one of control on a same level of page, a corresponding relationship between the first gesture and a response sequence between different levels of pages of the application and at least one control on a same level of page may be established and stored first.

Likewise, before a triggered control is determined according to a currently displayed page of the application and a pre-stored corresponding relationship between the second gesture and a response sequence between different levels of pages of the application and at least one control on a same level of page, a corresponding relationship between the second gesture and a response sequence between different levels of pages of the application and at least one control on a same level of page may be established and stored.

In the method for displaying an application page of a mobile terminal according to the example embodiment of the present disclosure, an application currently displayed by the mobile terminal is determined, and a screen of the mobile terminal is monitored. If a user is monitored to perform a first gesture on the screen of the mobile terminal, a triggered control is determined according to a currently displayed page of the application and a pre-stored corresponding relationship between the first gesture and a response sequence between different levels of pages of the application and at least one control on a same level of page, and a page corresponding to the triggered control is displayed, thus simplifying operation steps, reducing the number of confirmations, and making operations more convenient.

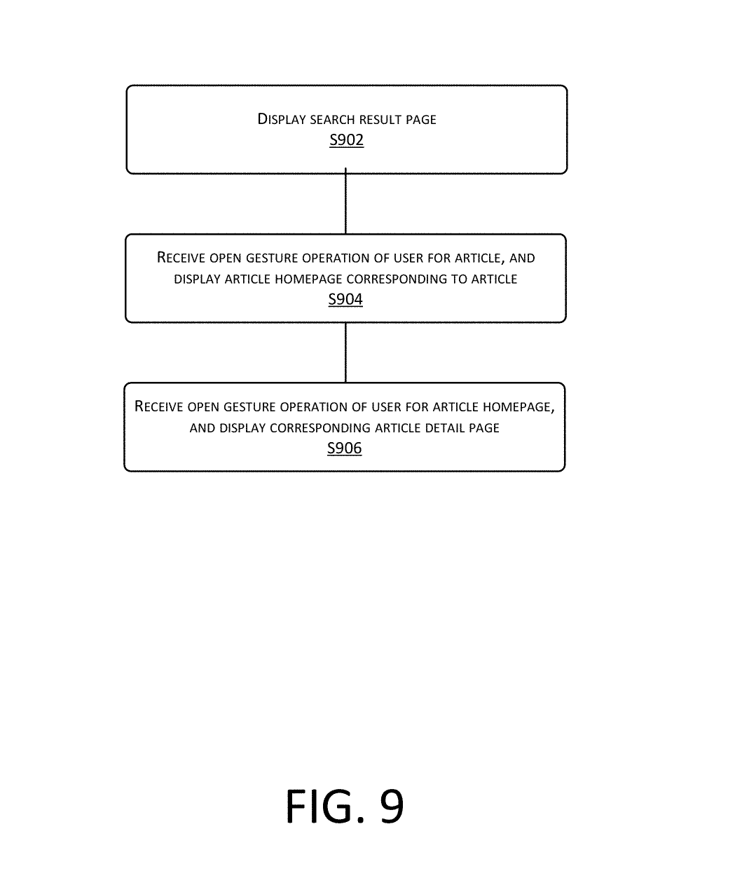

FIG. 9 is a flowchart of a method for displaying an application page of a mobile terminal according to a specific example embodiment of the present disclosure.

As shown in FIG. 9, the method for displaying an application page of a mobile terminal includes:

S902. Displaying a search result page.

As shown in FIG. 2, the search result page 202 is displayed on a screen of a mobile phone.

S904. Receiving an open gesture operation of a user for an article, and displaying an article homepage 302 corresponding to the article.

As shown in FIG. 3, after an open gesture operation of a user for an article is received, an article homepage 302 corresponding to the article is displayed by calling a control of the open gesture and the article homepage 302 corresponding to the article.

S906. Receiving an open gesture operation of the user for the article homepage 302, and displaying a corresponding article detail page 402.

As shown in FIG. 4, after an open gesture operation of the user for the article homepage 302 is received, a corresponding article detail page 402 is displayed by calling a control of the open gesture and the article detail page 402 corresponding to the article.

In addition, if the user wants to go back to the search result page 202, a pinch gesture may be performed. After a pinch gesture operation of the user is received on the article detail page 402, the user may go back to the article homepage 302 by calling the control of the pinch gesture and the article homepage 302, that is, the displayed page is jumped from FIG. 4 to FIG. 3. After the pinch gesture operation of the user is received on the article homepage 302, the user may go back to the search result page 202, that is, the displayed page is jumped from FIG. 3 to FIG. 2.

In the method for displaying an application page of a mobile terminal according to the example embodiment of the present disclosure, a gesture operation of a user is received, and a corresponding application page is displayed by calling a corresponding control, thus simplifying operation steps, reducing the number of confirmations, and making operations more convenient.

In order to implement the above example embodiments, the present disclosure further provides an apparatus for displaying an application page of a mobile terminal.

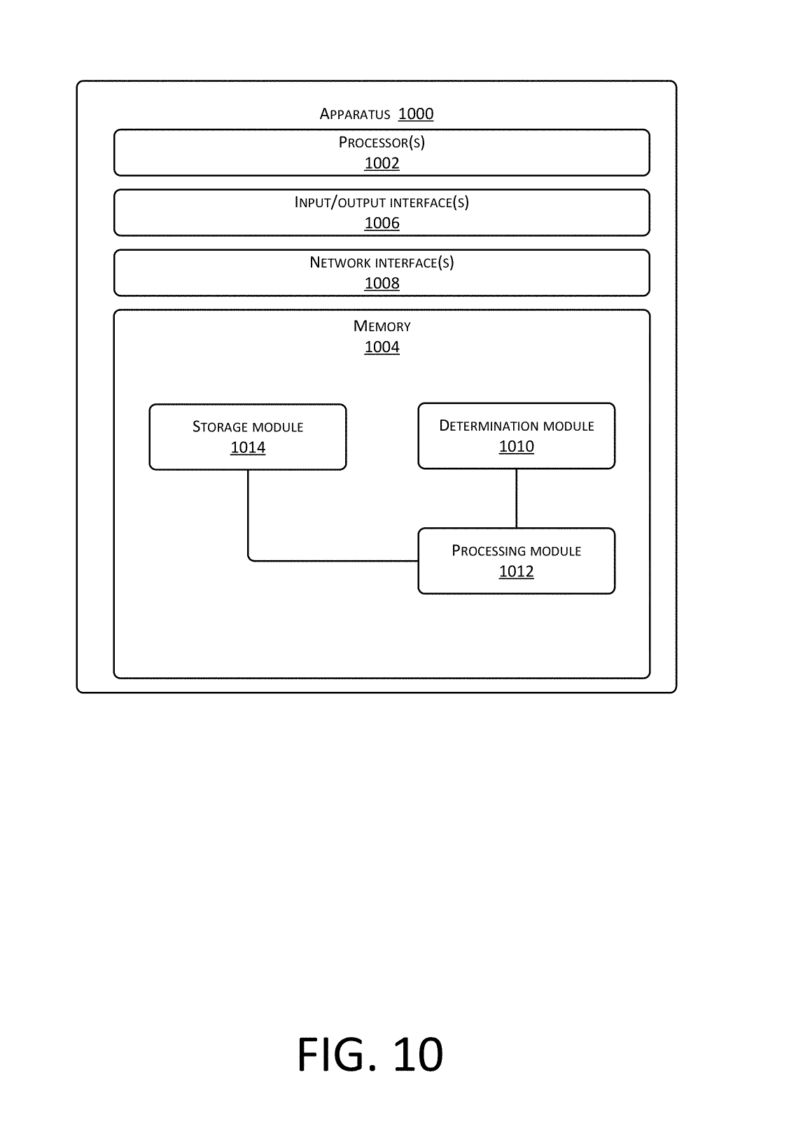

FIG. 10 is a schematic structural diagram of an apparatus for displaying an application page of a mobile terminal according to an example embodiment of the present disclosure.

As shown in FIG. 10, an apparatus 1000 for displaying an application page of a mobile terminal may include one or more processor(s) 1002 or data processing unit(s) and memory 1004. The apparatus 1000 may further include one or more input/output interface(s) 1006 and one or more network interface(s) 1008. The memory 1004 is an example of computer readable media.

The memory 1004 may store therein a plurality of modules or units including a determination module 1010 and a processing module 1012.

The determination module 1010 is configured to determine an application currently displayed by the mobile terminal.

In the example embodiment of the present disclosure, the determination module 1010 may determine an application currently displayed by the mobile terminal. The application currently displayed may be a communication and social application such as Weibo and WeChat, may also be an audio and video application such as a music player and a video player, and certainly, may also be a shopping application such as a group-buying application and an e-shop application. The mobile terminal may include a mobile phone, a tablet computer, a notebook computer, and the like. For example, the application currently displayed by a mobile phone is Taobao™ mobile.

The processing module 1012 is configured to monitor a screen of the mobile terminal; if a user is monitored to perform a first gesture on the screen of the mobile terminal, determine a triggered control according to a currently displayed page of the application and a pre-stored corresponding relationship between the first gesture and a response sequence between different levels of pages of the application and at least one control on a same level of page; and display a page corresponding to the triggered control.

In the example embodiment of the present disclosure, after the determination module 1010 determines the application currently displayed by the mobile terminal, the processing module 1012 may monitor a screen of the mobile terminal. If a user is monitored to perform a first gesture on the screen of the mobile terminal, a triggered control may be determined according to a currently displayed page of the application and a pre-stored corresponding relationship between the first gesture and a response sequence between different levels of pages of the application and at least one control on a same level of page, and a page corresponding to the triggered control is displayed. The first gesture may include, but is not limited to, an open gesture.

For example, the application currently displayed by the mobile phone is Taobao′ mobile. As shown in FIG. 2, the currently displayed page is a search result page 202, each article corresponds to one control, and an article homepage 302 corresponding to the article may be displayed if a corresponding control is triggered. When a user is monitored to perform an open gesture for an article on the search result page 202, an article homepage 302 corresponding to the article may be displayed by triggering the control, that is, the displayed page is jumped from FIG. 2 to FIG. 3. If the user wants to further view detailed information of the article, the user may perform the open gesture again, and after the operation is monitored, a detail page 402 corresponding to the article may be displayed by triggering a corresponding control, that is, the displayed page is jumped from FIG. 3 to FIG. 4.

Further, when the page corresponding to the triggered control is displayed, the processing module 1012 may determine a distance between corresponding fingers according to the first gesture, and judge whether the distance is greater than a predetermined threshold. If the distance is less than or equal to the predetermined threshold, the page corresponding to the triggered control is displayed. For example, when the user is monitored to perform an open gesture for an article on the search result page 202, if a distance between two fingers of the user is less than or equal to a predetermined threshold, an article homepage 302 corresponding to the article may be displayed, that is, the displayed page is jumped from FIG. 2 to FIG. 3.

If the distance is greater than the predetermined threshold, a thumbnail of the page corresponding to the triggered control is displayed according to the response sequence, and an operation of the user is monitored. If the user is monitored to perform a first operation, the page corresponding to the triggered control is displayed, and if the user is monitored to perform a second operation, a page corresponding to a next control is displayed according to the response sequence. The first operation may include an operation of loosening the fingers, and the second operation may include an operation of continuously performing the open gesture.

For example, if a distance between two fingers of the user is greater than the predetermined threshold, a thumbnail of the article homepage 302 corresponding to the article may be displayed. If the user wants to enter the article homepage 302 corresponding to the article, the operation of loosening the fingers may be performed. When the mobile phone monitors the operation, the displayed page is jumped from the search result page 202 to the article homepage 302 corresponding to the article, that is, from the thumbnail of the article homepage 302 to FIG. 3. If the user wants to enter a detail page 402 corresponding to the article, the open gesture may be continuously performed, and when the mobile phone monitors the operation, the displayed page is jumped from the search result page 202, through the thumbnail of the article homepage 302 corresponding to the article, to the detail page 402 corresponding to the article, that is, from FIG. 2, through a thumbnail preview of FIG. 3, to FIG. 4.

If a user is monitored to perform a second gesture on the screen of the mobile terminal, a triggered control is determined according to a currently displayed page of the application and a pre-stored corresponding relationship between the second gesture and a response sequence between different levels of pages of the application and at least one control on a same level of page, and a page corresponding to the triggered control is displayed. Wherein the second gesture may include, but is not limited to, a pinch gesture.

For example, an application currently displayed by a mobile phone is Taobao′ mobile. As shown in FIG. 4, the currently displayed page is a detail page 402 of an article, the detail page 402 corresponds to a control, and an article homepage 302 corresponding to the article may be displayed if a corresponding control is triggered. When a user is monitored to perform a pinch gesture on a detail page 402 of an article, an article homepage 302 corresponding to the article may be displayed by triggering the control, that is, the displayed page is jumped from FIG. 4 to FIG. 3. If the user wants to go back to the search result page 202, the pinch gesture may be performed again, and after the operation is monitored, the search result page 202 may be displayed by triggering the corresponding control, that is, the displayed page is jumped from FIG. 3 to FIG. 2.

It should be understood that the first gesture and the second gesture may also be other gestures, for example, a slide gesture and so on. If the mobile terminal does not have a touch screen, the detail page 402 may also be entered through another operation such as shake.

Certainly, after the user is monitored to perform an open or pinch gesture, a level guide prompt effect may also be displayed.

For example, as shown in FIG. 5, the number of levels is indicated with black points above the application page, and a slightly larger point indicates a level corresponding to the currently displayed page. When the user is monitored to perform an open gesture, arrows are used to indicate a jump from a current level to a next level, and the black point corresponding to the next level may become a white point, thus prompting the user. Certainly, the effect is not limited to that the black point becomes a white point, and another prompt effect may also be adopted. Likewise, when the user is monitored to perform a pinch gesture, as shown in FIG. 6, arrows are used to indicate a jump from a current level to a previous level, and the black point corresponding to the previous level may become a white point, thus prompting the user.

For another example, as shown in FIG. 7, the number of levels is indicated with circles, and a slightly thicker circle indicates a level corresponding to the currently displayed page. When the user is monitored to perform an open gesture, the circle becomes larger along with the gesture, and a paste effect is produced when the circle is about to reach a next level, thus prompting the user. Likewise, when the user is monitored to perform a pinch gesture, as shown in FIG. 8, the circle becomes smaller along with the gesture, and a paste effect is produced when the circle is about to reach a previous level, thus prompting the user.

In addition, the apparatus 1000 for displaying an application page of a mobile terminal according to the example embodiment of the present disclosure may further include a storage module 1014 stored on memory 1004.

The storage module 1014 is configured to, before a triggered control is determined according to a currently displayed page of the application and a pre-stored corresponding relationship between the first gesture and a response sequence between different levels of pages of the application and at least one control on a same level of page, establish and store a corresponding relationship between the first gesture and a response sequence between different levels of pages of the application and at least one control on a same level of page.

Certainly, the storage module 1014 may be further configured to, before a triggered control is determined according to a currently displayed page of the application and a pre-stored corresponding relationship between the second gesture and a response sequence between different levels of pages of the application and at least one control on a same level of page, establish and store a corresponding relationship between the second gesture and a response sequence between different levels of pages of the application and at least one control on a same level of page.

In the apparatus for displaying an application page of a mobile terminal according to the example embodiment of the present disclosure, an application currently displayed by the mobile terminal is determined, and a screen of the mobile terminal is monitored. If a user is monitored to perform a first gesture on the screen of the mobile terminal, a triggered control is determined according to a currently displayed page of the application and a pre-stored corresponding relationship between the first gesture and a response sequence between different levels of pages of the application and at least one control on a same level of page, and a page corresponding to the triggered control is displayed, thus simplifying operation steps, reducing the number of confirmations, and making operations more convenient.

In the description of the specification, the descriptions of the reference terms such as “one example embodiment”, “some example embodiments”, “an example”, “a specific example” and “some examples” mean that specific features, structures, materials or characteristics described in combination with the example embodiment(s) or example(s) are included in at least one example embodiment or example of the present disclosure. In the specification, the schematic expressions of the above terms are not necessarily aimed at the same example embodiment or example. Moreover, the described specific features, structures, materials or characteristics may be combined in an appropriate manner in any one or more example embodiments or examples. In addition, in the absence of mutual contradiction, those skilled in the art can integrate and combine the different example embodiments or examples and the features of the different example embodiments or examples described in the specification.

In addition, the terms “first” and “second” are merely used for description, but cannot be understood as indicating or implying relative importance or implicitly indicating the number of the technical features indicated. Thus, the features defined with “first” and “second” may explicitly or implicitly include at least one of the features. In the description of the present disclosure, the meaning of “more” is at least two, for example, two, three or the like, unless it is otherwise definitely and specifically defined.

Any process or method described in the flowcharts or in another manner here may be understood as indicating one or more modules, fragments or sections of codes of executable instructions for implementing specific logical functions or process steps, and the scope of the preferred implementations of the present disclosure includes additional implementation, wherein functions may be performed not in the order illustrated or discussed, including in a basically simultaneous manner according to the functions involved or in an opposite order, and this should be understood by those skilled in the art to which the example embodiments of the present disclosure belong.

Logics and/or steps indicated in the flowcharts or described in another manner here, for example, may be considered as a sequencing list of executable instructions for implementing logical functions, and may be specifically implemented in any computer readable medium, for an instruction executing system, apparatus or device (e.g., a computer-based system, including a processor system or other systems capable of fetching instructions from the instruction executing system, apparatus or device and executing the instructions) to use, or be combined with the instruction executing system, apparatus or device for use. In terms of the specification, the “computer readable medium” may be any apparatus that may include, store, communicate, propagate, or transmit programs for the instruction executing system, apparatus or device to use or be combined with the instruction executing system, apparatus or device for use. A more specific example (non-exhaustive list) of the computer readable medium includes the followings: an electric connecting portion (electronic apparatus) having one or more wires, a portable computer disk box (magnetic apparatus), a random access memory (RAM), a read only memory (ROM), an electrically erasable programmable read only memory (EPROM or flash memory), a fiber optic apparatus, and a portable compact disk read only memory (CDROM). In addition, the computer readable medium may even be a piece of paper or another appropriate medium on which the program can be printed, because the program can be obtained electronically, for example, by optically scanning the paper or the another medium and then by editing, interpreting or processing in another appropriate manner if necessary, and then is stored in a computer memory. According to the definition herein, the computer readable media does not include transitory computer readable media (transitory media), for example, a modulated data signal and a carrier.

It should be understood that various parts of the present disclosure may be implemented with hardware, software, firmware or a combination thereof. In the above implementations, multiple steps or methods may be implemented by software or firmware stored in a memory and executed by an appropriate instruction executing system. For example, if they are implemented by hardware, as in another implementation, they may be implemented by any of the following technologies well-known in this field or a combination thereof: a discrete logic circuit having a logic gate circuit for implementing a logic function on a data signal, a dedicated integrated circuit having an appropriate combined logic gate circuit, a programmable gate array (PGA), a field programmable gate array (FPGA), and the like.

Those of ordinary skill in the art can understand that implementation of all or some steps carried in the methods of the above example embodiments may be completed by instructing related hardware through a program. The program may be stored in a computer readable storage medium. When the program is executed, one of the steps of the method example embodiments or a combination thereof is included.

In addition, various functional units in the example embodiments of the present disclosure may be integrated into one processing module, or each unit may exist physically alone, or two or more units may be integrated into one module. The integrated module may be implemented in the form of hardware, and may also be implemented in the form of a software functional module. When implemented in the form of the software functional module and sold or used as a separate product, the integrated module may also be stored in a computer readable storage medium.

The storage medium mentioned above may be a read only memory, a magnetic disk, an optical disk, or the like. Although the example embodiments of the present disclosure have been illustrated and described above, it may be understood that the above example embodiments are exemplary and cannot be construed as limitations to the present disclosure. Those of ordinary skill in the art can change, modify, replace and transform the above example embodiments within the scope of the present disclosure.

1. A method comprising:
displaying a first page of an application on a screen of a mobile terminal;
monitoring one or more gestures on the screen of the mobile terminal;
in response to determining a first gesture on the screen of the mobile terminal, determining a second page of the application according to a corresponding relationship between the first gesture and a response sequence between different levels of pages of the application; and
displaying the second page of the application on the screen of the mobile terminal

2. The method of claim 1, further comprising establishing and storing the corresponding relationship between the first gesture and the response sequence between different levels of pages of the application.

3. The method of claim 1, wherein the determining the second page of the application according to a corresponding relationship between the first gesture and a response sequence between different levels of pages of the application includes:
determining a trigger control of the first page.

4. The method of claim 1, further comprising:
in response to determining a second gesture on the screen of the mobile terminal, determining a third page of the application according to another corresponding relationship between the second gesture and a response sequence between different levels of pages of the application.

5. The method of claim 4, further comprising establishing and storing the another corresponding relationship between the second gesture and the response sequence between different levels of pages of the application.

6. The method of claim 4, wherein:
the first gesture is one of a pinch gesture and an open gesture.

7. The method of claim 6, wherein:
the second gesture is the other one of the pinch gesture and the open gesture.

8. The method of claim 1, wherein the displaying the second page of the application on the screen of the mobile terminal includes:
determining, according to the first gesture, a distance between corresponding fingers;
determining that the distance is less than or equal to a predetermined threshold; and
displaying the second page.

9. The method of claim 7, wherein the displaying the second page of the application on the screen of the mobile terminal includes:
determining, according to the first gesture, a distance between corresponding fingers;
determining that the distance is greater than the predetermined threshold; and
displaying, according to the response sequence, a thumbnail of the second page.

10. The method of claim 1, wherein the determining the second page of the application according to the corresponding relationship between the first gesture and the response sequence between different levels of pages of the application includes:
determining an operation on the first page corresponding to the first gesture.

11. An apparatus comprising:
one or more processors; and
one or more memories stored thereon computer readable instructions that, when executed by the one or more processors, cause the one or more processors to perform acts comprising:
determining an application currently displayed by a mobile terminal;
monitoring a screen of the mobile terminal;
in response to determining that a first gesture on the screen of the mobile terminal, determining a triggered control according to a currently displayed page of the application and a pre-stored corresponding relationship between the first gesture and a response sequence between different levels of pages of the application and at least one control on a same level of page; and
display a page corresponding to the triggered control.

12. The apparatus of claim 11, wherein the acts further comprise:
in response to determining a second gesture on the screen of the mobile terminal, determine an another triggered control according to the currently displayed page of the application and a pre-stored another corresponding relationship between the second gesture and a response sequence between different levels of pages of the application and at least one control on the same level of page; and
display another page corresponding to the another triggered control.

13. The apparatus of claim 12, wherein the acts further comprise:
establishing and storing the another corresponding relationship between the second gesture and the response sequence between different levels of pages of the application and at least one control on the same level of page.

14. The apparatus of claim 13, wherein:
the first gesture is one of a pinch gesture and an open gesture; and
the second gesture is the other one of the pinch gesture and the open gesture.

15. The apparatus of claim 11, wherein the acts further comprise:
establishing and storing the another corresponding relationship between the second gesture and the response sequence between different levels of pages of the application and at least one control on the same level of page.

16. The apparatus of claim 15, wherein the displaying the page corresponding to the triggered control includes:
determining, according to the first gesture, a distance between corresponding fingers;
determining that the distance is less than or equal to a predetermined threshold; and
displaying the page corresponding to the triggered control.

17. The apparatus of claim 16, wherein the acts further comprise:
determining, according to the first gesture, a distance between corresponding fingers;
determining that the distance is greater than the predetermined threshold; and
displaying, according to the response sequence, a thumbnail of a page corresponding to the triggered control.

18. The apparatus of claim 17, wherein the acts further comprise:
monitoring an operation on the screen; and
in response to determining a first operation on the screen, displaying the page corresponding to the triggered control.

19. One or more memories stored thereon computer readable instructions that, when executed by one or more processors, cause the one or more processors to perform acts comprising:
displaying a first page of an application on a screen of a mobile terminal;
monitoring one or more gestures on the screen of the mobile terminal; and
in response to determining a first gesture on the screen of the mobile terminal, determining a second page of the application according to a corresponding relationship between the first gesture and a response sequence between different levels of pages of the application.

20. The one or more memories of claim 20, wherein the acts further comprise displaying the second page of the application on the screen of the mobile terminal.
